(19) United States
(12) Patent Application Publication
(10) Pub. No.: US 2019/0065793 A1
(43) Pub. Date: Feb. 28, 2019

(54) COIL MODULE AND MOBILE TERMINAL USING THE SAME

(71) Applicant: Samsung Electro-Mechanics Co., Ltd., Suwon-si (KR)

(72) Inventors: Hee Seung KIM, Suwon-si (KR); Young Seung ROH, Suwon-si (KR); Jae Sun WON, Suwon-si (KR); Gie Hyoun KWEON, Suwon-si (KR)

(73) Assignee: Samsung Electro-Mechanics Co., Ltd., Suwon-si (KR)

(21) Appl. No.: 15/992,549

(22) Filed: May 30, 2018

(30) Foreign Application Priority Data
Aug. 31, 2017 (KR) 10-2017-0110926

(51) Int. Cl. G06K 7/08; H01F 27/28; H01F 27/24; G06Q 20/32

(52) U.S. Cl. CPC G06K 7/087; H01F 27/2804; H04B 5/0081; G06Q 20/3278; H01F 27/24

(57) ABSTRACT

A coil module includes a substrate including a magnetic body and a through-hole; a first coil including a spiral pattern formed on one surface of the substrate; and a second coil including at least one solenoid pattern formed around the magnetic body, wherein the first coil and the second coil are formed around the through-hole.

### CROSS-REFERENCE TO RELATED APPLICATIONS

This application claims the benefit under 35 USC 119(a) of Korean Patent Application No. 10-2017-0110926 filed on Aug. 31, 2017, in the Korean Intellectual Property Office, the entire disclosure of which is incorporated herein by reference for all purposes.

### BACKGROUND

### 1. Field

The present disclosure relates to a coil module and a mobile terminal using the same.

### 2. Description of Related Art

As portable terminals such as smartphones have become widespread and functions thereof have improved, a payment method of a portable terminal using short-range communication has emerged.

Such a short-range communication method employs a short-range wireless communication method such as a near-field communication (NFC) method.

In addition, a magnetic secure transmission (MST) method capable of performing payment by directly and wirelessly communicating with a magnetic card reader has recently been proposed.

To provide a mobile terminal with the ability to make payments by the NFC method and the MST method, both an NFC coil and an MST coil need to be mounted in the mobile terminal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a coil module includes a substrate including a magnetic body and a through-hole; a first coil including a spiral pattern formed on one surface of the substrate; and a second coil including at least one solenoid pattern formed around the magnetic body, wherein the first coil and the second coil are formed around the through-hole.

The spiral pattern may be formed around a first axis perpendicular to a surface of the substrate, and the solenoid pattern may be formed around a second axis parallel to the surface of the substrate.

The first coil may be formed on an upper portion of the substrate above the through-hole, and the second coil may be formed on a portion of the substrate on either one or both of a left side and a right side of the through-hole.

The substrate may be a multilayer substrate formed by stacking a plurality layers, and may include a first magnetic body disposed in or on any one layer among the plurality of layers, and a second magnetic body disposed in or on a same layer among the plurality of layers as the first magnetic body, the first magnetic body may be formed in a region of the substrate opposing the first coil, and the second coil may be wound around the second magnetic body.

The substrate may be a multilayer substrate formed by stacking a plurality layers, and may include a first magnetic body disposed in or on a first layer among the plurality of layers, and a second magnetic body disposed in or on a second layer among the plurality of layers different from the first layer, the first magnetic body may be formed in a region of the substrate opposing the first coil, and the second coil may be wound around the second magnetic body.

The first coil may be formed along an outer portion of the substrate, the outer portion including an upper portion of the substrate above the through-hole, and the second coil may be formed in a portion of the substrate on either one or both a left side and a right side of the through-hole.

The at least one solenoid pattern may includes a first solenoid pattern formed on a portion of the substrate on a left side of the through-hole; and a second solenoid pattern formed on a portion of the substrate on a right side of the through-hole.

The first solenoid pattern and the second solenoid pattern may be wound on different portions of the magnetic body.

The magnetic body may have a shape of a U having a first leg and a second leg, the first solenoid pattern may be wound on the first leg of the magnetic body, and the second solenoid pattern may be wound on the second leg of the magnetic body.

A number of windings of the first solenoid pattern may be different from a number of windings of the second solenoid pattern.

The at least one solenoid pattern may be one solenoid pattern formed on a portion of the substrate on either a left side or a right side of the through-hole.

The at least one solenoid pattern may include a plurality of first patterns formed on the one surface of the substrate; a plurality of second patterns formed on another surface of the substrate; and a plurality of vias penetrating through the substrate and electrically connecting both ends of the plurality of first patterns to both ends of the plurality of second patterns to form the at least one solenoid pattern around the magnetic body.

The substrate may be a magnetic substrate formed of a magnetic material and constituting the magnetic body, the spiral pattern may be formed on one surface of the magnetic substrate, and the at least one solenoid pattern may include a plurality of first patterns formed on the one surface of the magnetic substrate; a plurality of second patterns formed on another surface of the magnetic substrate; and a plurality of vias penetrating through the magnetic substrate and electrically connecting both ends of the plurality of first patterns to both ends of the plurality of second patterns to form the at least one solenoid pattern around the magnetic body.

The coil module may further include a magnetic plate adjacent to the substrate and forming a magnetic path configured to concentrate a magnetic field formed by the coil module.

In another general aspect, a mobile terminal includes a metal case formed of a metal and including a camera hole; and a coil module including a substrate including a through-hole; a spiral coil formed on the substrate, at least a portion of the spiral coil being formed on a portion of the substrate above the through-hole; and at least one solenoid coil formed on a portion of the substrate on either one or both of a left side and a right side of the through-hole, wherein the coil module is disposed in or on the metal case so that the through-hole is aligned with the camera hole.

The camera hole may be formed in an upper portion of the metal case, the metal case may further include a first slit formed in the upper portion of the metal case adjacent to the camera hole; and a second slit formed in a lower portion of the metal case, and the mobile terminal may further include a magnetic plate disposed in or on the metal case and having one end adjacent to the coil module and another end adjacent to the second slit.

In another general aspect, a coil module includes a substrate including a magnetic body and a through-hole; a spiral coil formed on the substrate so that at least a portion of the spiral coil is formed in a first region of the substrate between the through-hole and a first edge of the substrate; and a solenoid coil formed around the magnetic body and formed in a second region of the substrate between the through-hole and a second edge of the substrate oriented in a different direction than the first edge of the substrate.

The spiral coil may be formed along a portion of the substrate adjoining an entire perimeter of the substrate including the first edge of the substrate and the second edge of the substrate so that the through-hole and the solenoid coil are disposed within the spiral coil.

An entirety of the spiral coil may be formed in the first region of the substrate, and the substrate may further include another magnetic body disposed in the first region of substrate and opposing the spiral coil.

The magnetic body may be disposed inside the substrate, and the solenoid coil may include a plurality of first vias penetrating through the substrate on one side of the magnetic body; a plurality of second vias penetrating through the substrate on an opposite side of the magnetic body; a plurality of first patterns formed on a first surface of the substrate, each of the first patterns connecting a different one of the first vias to a different one of the second vias; and a plurality of second patterns formed on a second surface of the substrate, each of the second patterns connecting a different one of the first vias to a different one of the second vias.

Other features and aspects will be apparent from the following detailed description, the drawings, and the claims.

### BRIEF DESCRIPTION OF DRAWINGS

FIG. 1 is a view illustrating an example of an application of a coil module.

FIG. 2 is a view illustrating another example of an application of a coil module.

FIG. 3 is a plan view illustrating an example of a coil module.

FIG. 4A is a perspective view illustrating an example of the coil module illustrated in FIG. 3.

FIG. 4B is an exploded perspective view illustrating an example of the coil module illustrated in FIG. 4A.

FIGS. 5 through 13 are plan views illustrating various modified examples of a coil module.

FIGS. 14 and 15 are views illustrating various examples of a case of a mobile terminal and a coil module applied thereto.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

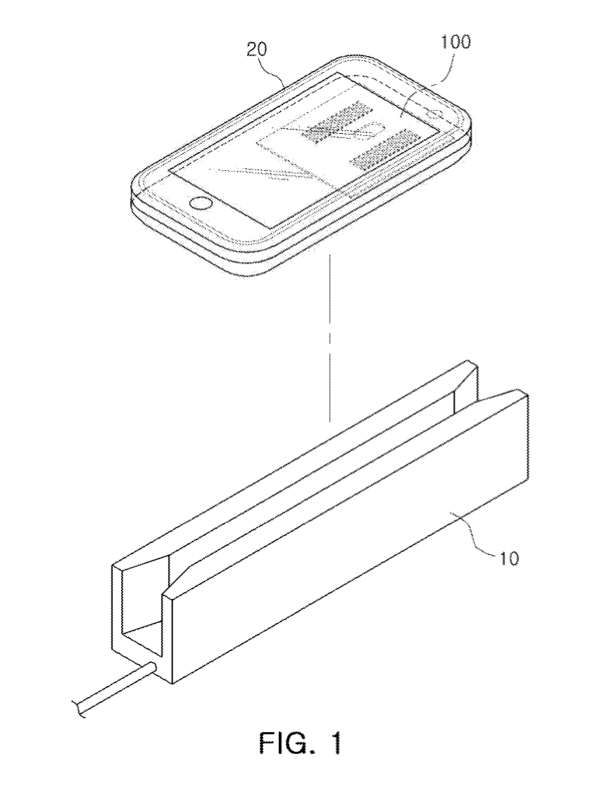

FIG. 1 is a view illustrating an example of an application of a coil module.

A coil module 100 is applied to a mobile terminal 20. The coil module 100 may be an integral component of the mobile terminal 20 or may be a separate component that is coupled to the mobile terminal 20.

The coil module 100 includes a plurality of different coils to support a plurality of communication schemes. As an example, the coil module 100 includes a near-field communication (NFC) coil for supporting a short-range communication scheme and a magnetic secure transmission (MST) coil for supporting magnetic secure transmission. FIG. 1 illustrates an example in which card information is provided to a magnetic card reader 10 using the MST coil. The coil module 100 may include a solenoid type MST coil that is wound around an axis of the mobile terminal 20 in a length direction thereof to be magnetically coupled to the magnetic card reader 10.

In this example, the coil module 100 operates as a transmission coil and provides predetermined information, for example, card information, to the magnetic card reader 10, which is a receiving apparatus.

That is, the coil module 100 forms a magnetic field and the formed magnetic field generates a voltage across a magnetic head of the magnetic card reader 10, enabling the coil module 100 to wirelessly transmit the card information to the magnetic card reader 10.

Although not illustrated in FIG. 1, the coil module 100 may also include an NFC coil for performing wireless communication with an NFC card reader.

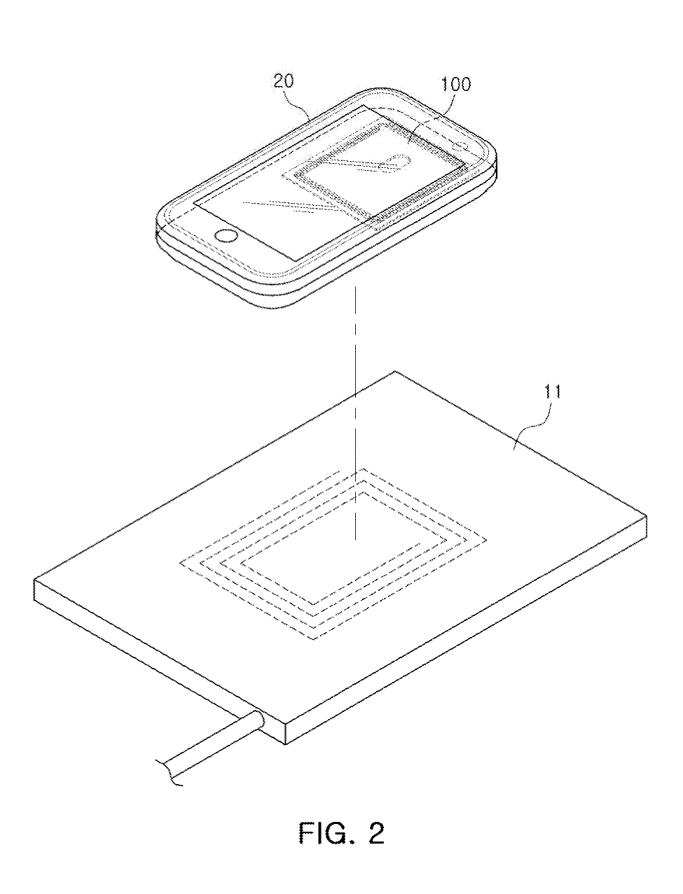

Hereinafter, an example to which the NFC coil module is applied will be described with reference to FIG. 2.

FIG. 2 is a view illustrating another example of an application of a coil module.

FIG. 2 illustrates an example in which the coil module 100 wirelessly communicates with an NFC card reader 11.

The coil module 100 includes a plurality of different coils to support a plurality of communication schemes. As an example, the coil module 100 includes an NFC coil for supporting a short-range communication corresponding to a case illustrated in FIG. 2, and an MST coil for supporting magnetic secure transmission corresponding to a case illustrated in FIG. 1.

Similarly to the example illustrated in FIG. 2, the coil module 100 wirelessly communicates with the NFC reader 11 to transmit or receive information.

As described with reference to FIGS. 1 and 2, the coil module 100 includes the plurality of different coils for supporting the different communication schemes. In addition, the coil module 100 may include the plurality of coils on one substrate to miniaturize the plurality of coils.

The plurality of coils included in the coil module 100 may be wound in different directions depending on a communication target.

As an example, corresponding to the NFC scheme including a plane coil as in the example illustrated in FIG. 2, the coil module 100 includes a spiral type NFC coil wound on a plane parallel to the substrate.

As another example, by considering a typical layout between the magnetic card reader 10 and the mobile terminal 20 as in the example illustrated in FIG. 1, the coil module 100 includes a solenoid type MST coil wound around an axis parallel to the substrate, that is, the mobile terminal 20, for example, an axis of the mobile terminal 20 in a length direction thereof.

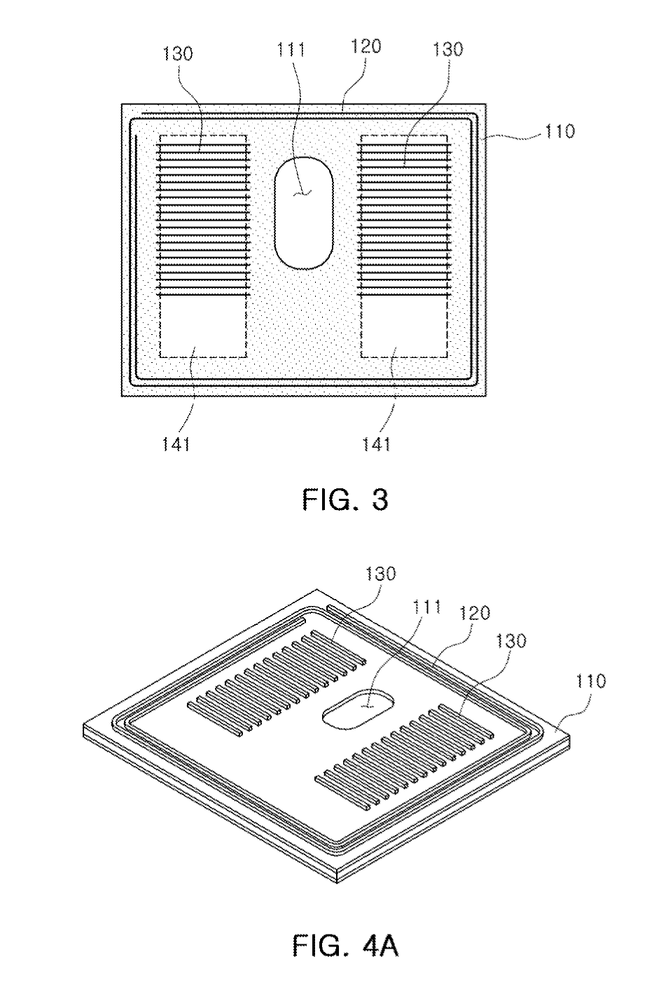

Various examples of the coil module 100 will be described in more detail with reference to FIGS. 3 through 13.

FIG. 3 is a plan view illustrating an example of a coil module. Referring to FIG. 3, the coil module 100 includes a substrate 110, a first coil 120 formed in a spiral pattern, and second coils 130 formed in a solenoid pattern.

A through-hole 111 is formed in a central portion of the substrate 110. The central portion is a portion of the substrate 110 between opposite side portions of the substrate 110. In the example illustrated in FIG. 3, the central portion of the substrate 110 is a portion of the substrate 110 between the left and right side portions of the substrate 110, and extends from the top to the bottom of the substrate 110.

The through-hole 111 provides a space required by one or more component of the mobile terminal, for example, a camera module. Therefore, the coil module 100 has a spatial configuration for mounting different kinds of coils while leaving space for the through-hole 111.

In the example illustrated in FIG. 3, the substrate 110 includes two magnetic bodies 141, but is not limited to two magnetic bodies 141, and may include one magnetic body 141 or three or more magnetic bodies 141.

The first coil 120 is formed on one surface of the substrate and includes a spiral type pattern (hereinafter, referred to as a ‘spiral pattern’).

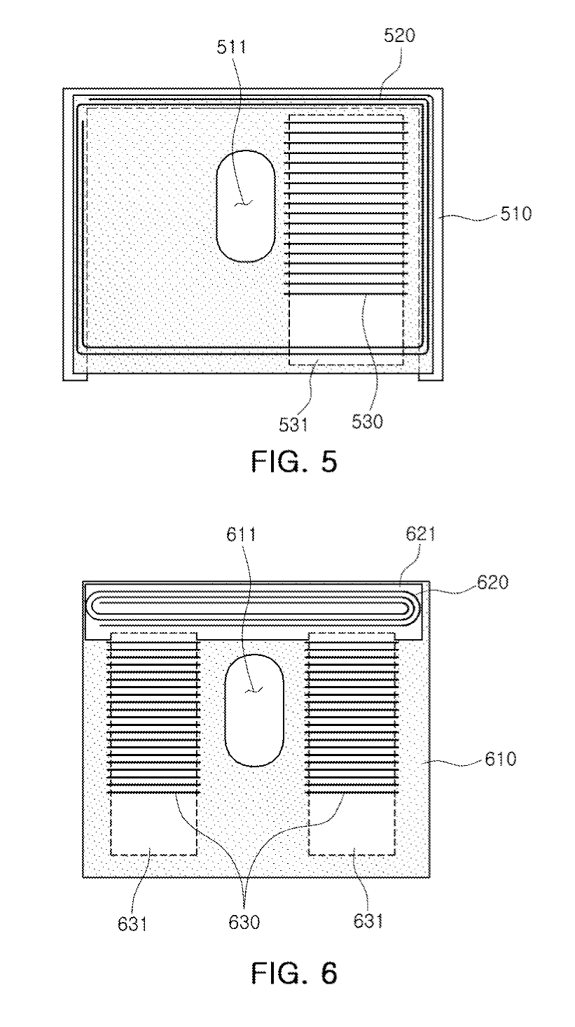

At least a portion of the first coil 120 is formed above the through-hole 111, that is, on a portion of the substrate above the through-hole 111. In the illustrated example, the first coil 120 is formed along an outer portion of the substrate, but this is illustrative. The form of the first coil may be modified in various ways as in the examples illustrated in FIGS. 5 through 13.

The second coils 130 each include a solenoid type coil pattern (hereinafter, referred to as a ‘solenoid pattern’) wound around one of the magnetic bodies 141 included in the substrate 110.

The first coil 120 and the second coils 130 are formed around the through-hole 111, and are spaced apart from each other by a predetermined distance. For example, a portion of the first coil 120 is formed above the through-hole 111 and the second coils 130 are formed on the left and right sides of the through-hole 111. This is to significantly reduce mutual interference while forming three coils around the through-hole 111 because the through-hole 111 is formed in the central portion of the coil module 100.

In other words, the first coil 120 is formed on the substrate 110 so that at least a portion of the first coil 120 is formed in a first region of the substrate 110 between the through-hole 111 and a first edge of the substrate 110 (the top edge of the substrate 110 in the example illustrated in FIG. 3).

Each of the second coils 130 is formed in a second region of the substrate 111 between the through-hole 111 and a second edge of the substrate oriented in a different direction than the first edge of the substrate 110 (the left edge of the substrate 110 for the left second coil 130 and the right edge of the substrate 110 for the right second coil 130 in the example illustrated in FIG. 3).

In the example illustrated in FIG. 3, the first coil 120 is formed along an outer portion of the substrate 110 adjoining an entire perimeter of the substrate 110 including the first edge of the substrate 110 and the second edge of the substrate 110 so that the through-hole 111 and the second coils 130 are disposed within the first coil 120.

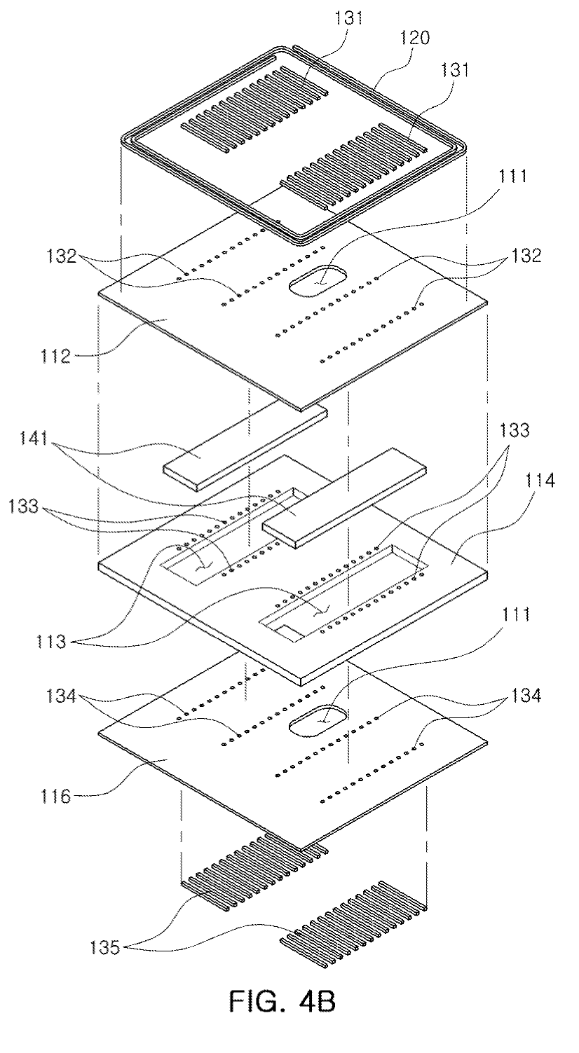

FIG. 4A is a perspective view illustrating an example of the coil module illustrated in FIG. 3, and FIG. 4B is an exploded perspective view illustrating an example of the coil module illustrated in FIG. 4A.

Referring to FIGS. 4A and 4B, the coil module includes the substrate 110 in which the through-hole 111 is formed, and the first coil 120 and the second coils 130 formed on the substrate 110.

The first coil 120 is wound around a virtual first axis perpendicular to the substrate on an upper surface of the substrate 110. That is, the first coil 120 is wound in a spiral shape around the virtual first axis perpendicular to the substrate.

The second coils 130 include a plurality of first patterns 131 formed on the upper surface of the substrate 110, a plurality of second patterns 135 formed on a lower surface of the substrate 110, and a plurality of vias 132, 133, and 134 penetrating through the substrate 110 and electrically connecting both ends of the plurality of first patterns 131 to both ends of the plurality of second patterns 135.

The substrate 110 is a multilayer substrate formed by stacking a plurality of layers.

Referring to the illustrated example, the substrate 110 includes a first plate 112, a second plate 114, and a third plate 116 stacked in the order listed. The second plate 114 includes cavities 113, and the magnetic bodies 141 are disposed in the cavities 113.

The first plate 112 and the third plate 116 are disposed on an upper surface and a lower surface of the second plate 114 in which the cavities are formed.

The plurality of vias 132, 133, and 134 that electrically connect both ends of the first patterns 131 to both ends of the second patterns 135 are respectively formed in the first plate 112, the second plate 114, and the third plate 116.

Therefore, the first patterns 131, the second patterns 135, and the plurality of vias 132, 133, and 134 formed in the first plate 112, the second plate 114, and the third plate 116 form two solenoid coils 130 wound around the magnetic bodies 141.

A portion of the first coil 120 is formed above the through-hole 111, and the second coils 130 are formed on the left and right sides of the through-hole 111.

As described above, the coil module 100 includes the first or spiral coil 120 and the second or solenoid coils 130 that are wound in different directions formed around the through-hole 111 on one substrate 110.

The first coil 110 of the spiral form is used as the NFC coil, and the second coils 130 of the solenoid form are used as the MST coil.

In the example illustrated in FIGS. 3, 4A, and 4B, the second coils 130 are a first solenoid coil 130 formed on the left side of the through-hole 111 and a second solenoid coil 130 formed on the right side of the through-hole 111, but this is merely illustrative. Therefore, the shape or size of the first coil 120 and the second coils 130 may be modified in various ways.

Hereinafter, various modified examples of coil modules will be described with reference to FIGS. 5 through 13.

Referring to an example illustrated in FIG. 5, a coil module includes a substrate 510 including a through-hole 511, and a first coil 520 and a second coil 530 formed around the through-hole 511.

The substrate 510 includes a magnetic body 531 inside or outside of the substrate 510, and the second coil 530 is a solenoid coil wound around the magnetic body 531.

In the example illustrated in FIG. 5, the first coil 520 is a spiral coil wound along an outer portion of the substrate 510 including an upper portion of the substrate 510, that is, a portion of the substrate 510 above the through-hole 511, and the second coil 530 is one solenoid coil formed on the right side of the through-hole 511.

In this example in which the second coil 530 is one solenoid coil 530, a width of the magnetic body 531 is larger than a width of the magnetic body 141 in the example of FIGS. 3, 4A, and 4B in which the second coil 130 includes the two solenoid coils 130. This enables a sufficiently strong magnetic field to be formed even with the one solenoid coil 530.

Referring to an example illustrated in FIG. 6, a coil module includes a substrate 610 including a through-hole 611, and a first coil 620 and second coils 630 formed around the through-hole 611.

The substrate 610 includes a first magnetic body 621 and second magnetic bodies 631 inside or outside of the substrate 610.

The first magnetic body 621 is for the first coil 620, and is formed in a region of the substrate 610 opposing the first coil 620.

The second magnetic bodies 631 are for the second coils 630, and the second coils 630 are wound around the second magnetic bodies 631.

The first magnetic body 621 and the second magnetic bodies 631 are formed in or on the same layer of the substrate 610. In one example, the substrate 610 is a multilayer substrate formed by stacking a plurality of layers, and the first magnetic body 621 and the second magnetic bodies 631 are formed together in or on any one layer of the multilayer substrate.

The illustrated example illustrates that the first magnetic body 621 and the second magnetic bodies 631 are partially in contact with each other, but this is illustrative. Alternatively, the first magnetic body 621 and the second magnetic bodies 631 may be spaced apart from each other on the same layer.

The first coil 620 is a spiral coil wound on one surface of the first magnetic body 621 in an upper portion of the substrate 610, that is, in a portion of the substrate 610 above the through-hole 611.

The second coils 630 are two solenoid coils 630 wound around the second magnetic bodies 631 on the left and right sides of the through-hole 611.

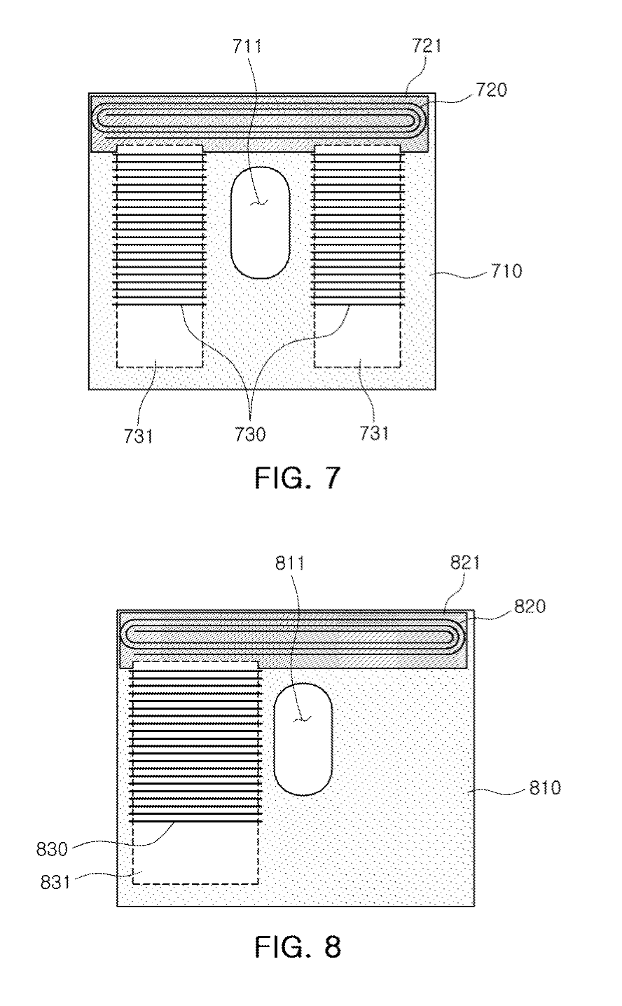

Referring to an example illustrated in FIG. 7, a coil module includes a substrate 710 including a through-hole 711, and a first coil 720 and second coils 730 formed around the through-hole 711.

The substrate 710 includes a first magnetic body 721 and second magnetic bodies 731 inside or outside of the substrate 710.

The first magnetic body 621 is for the first coil 720, and is formed in a region of the substrate 710 opposing the first coil 720.

The second magnetic bodies 731 are for the second coils 730, and the second coils 730 are wound around the second magnetic bodies 731.

The first magnetic body 721 and the second magnetic bodies 731 are formed in or on different layers of the substrate 710.

In one example, the substrate 710 is a multilayer substrate formed by stacking a plurality of layers. The first magnetic body 721 is formed in a first layer among the plurality of layers and the second magnetic bodies 731 are formed in a second layer different from the first layer among the plurality of layers.

In another example, the first magnetic body 721 is formed on an upper surface of the substrate 710 and the second magnetic bodies 731 are formed inside the substrate 710.

The first coil 720 is a spiral coil wound on one surface of the first magnetic body 721 in an upper portion of the substrate 710, that is, a portion of the substrate 710 above the through-hole 711.

The second coils 730 are two solenoid coils 730 wound around the second magnetic bodies 731 on the left and right sides of the through-hole 711.

Referring to an example illustrated in FIG. 8, a coil module includes a substrate 810 including a through-hole 811, and a first coil 820 and a second coil 830 formed around the through-hole 811.

The substrate 810 includes a first magnetic body 821 and a second magnetic body 831 inside or outside of the substrate 810. The first magnetic body 821 and the second magnetic body 831 are formed in or on different layers of the substrate 810. In one example, the first magnetic body 821 is formed on an upper surface of the substrate 810 and the second magnetic body 831 is formed inside the substrate 810.

The first coil 820 is a spiral coil wound on one surface of the first magnetic body 821 in an upper portion of the substrate 810, that is, a portion of the substrate 810 above the through-hole 811.

The second coil 830 is one solenoid coil 830 wound around the second magnetic body 831 on the left side of the through-hole 811.

In this example in which the second coil 830 is one solenoid coil 830, a width of the second magnetic body 831 is larger than a width of the second magnetic body 731 in the example of FIG. 7 in which the second coil 730 includes the two solenoid coils 730. This enables a sufficiently strong magnetic field to be formed even with the one solenoid coil 830.

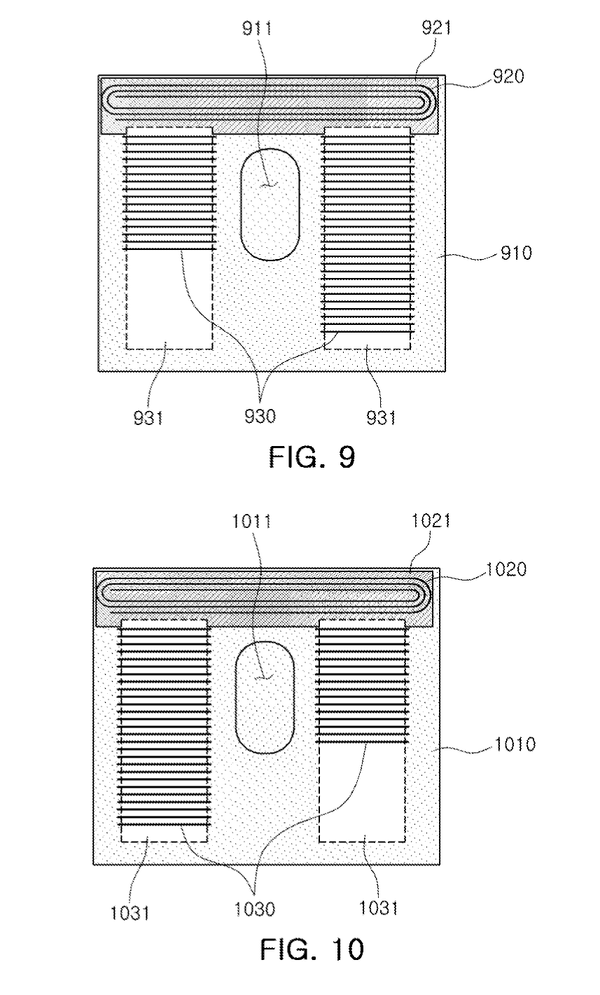

Referring to an example illustrated in FIG. 9, a coil module includes a substrate 910 including a through-hole 911, and a first coil 920 and second coils 930 formed around the through-hole 911.

The substrate 910 includes a first magnetic body 921 and second magnetic bodies 931 inside or outside of the substrate 910. The first magnetic body 921 and the second magnetic bodies 931 are formed in or on different layers of the substrate 910. In one example, the first magnetic body 921 is formed on an upper surface of the substrate 910, and the second magnetic bodies 931 are formed inside the substrate 910.

The first coil 920 is a spiral coil wound on one surface of the first magnetic body 921 in an upper portion of the substrate 910, that is, a portion of the substrate 910 above the through-hole 911.

The second coils 930 are two solenoid coils 930 wound around the second magnetic bodies 931 in portions of the substrate 910 on the left and right sides of the through-hole 911.

In the example illustrated in FIG. 9, the two solenoid coils 930 of the second coils 930 have different numbers of windings, with the left solenoid coil 930 having a smaller number of windings than the right solenoid coil 930. This enables a uniform magnetic field to be formed by the solenoid coils 930 outside a mobile terminal despite a shape of accessory components that are asymmetrically disposed in the mobile terminal or an asymmetrical slit in a metal case of the mobile terminal.

Referring to an example illustrated in FIG. 10, a coil module includes a substrate 1010 including a through-hole 1011, and a first coil 1020 and second coils 1030 formed around the through-hole 1011.

The substrate 1010 includes a first magnetic body 1021 and second magnetic bodies 1031 inside or outside of the substrate 1010. The first magnetic body 1021 and the second magnetic bodies 1031 are formed in or on different layers of the substrate 1010. In one example, the first magnetic body 1021 is formed on an upper surface of the substrate 1010, and the second magnetic bodies 1031 are formed inside the substrate 1010.

The first coil 1020 is a spiral coil wound on one surface of the first magnetic body 1021 in an upper portion of the substrate 1010, that is, a portion of the substrate 1010 above the through-hole 1011.

The second coils 1030 are two solenoid coils 1030 wound around the second magnetic bodies 1031 in portions of the substrate 1010 on the left and right sides of the through-hole 1011.

In the example illustrated in FIG. 10, the two solenoid coils 1030 of the second coils 1030 have different numbers of windings, with the left solenoid coil 1030 having a greater number of windings than the right solenoid coil 1030. This enables a uniform magnetic field to be formed by the solenoid coils 1030 outside a mobile terminal despite a shape of accessory components that are asymmetrically disposed in the mobile terminal or an asymmetrical slit in a metal case of the mobile terminal.

The example illustrated in FIG. 10 is the same as the example illustrated in FIG. 9, except that in the example illustrated in FIG. 10, the right solenoid coil 1030 has a fewer number of windings than the left solenoid coil 1030, while in the example illustrated in FIG. 9, the left solenoid coil 930 has a fewer number of windings that the right solenoid coil 930.

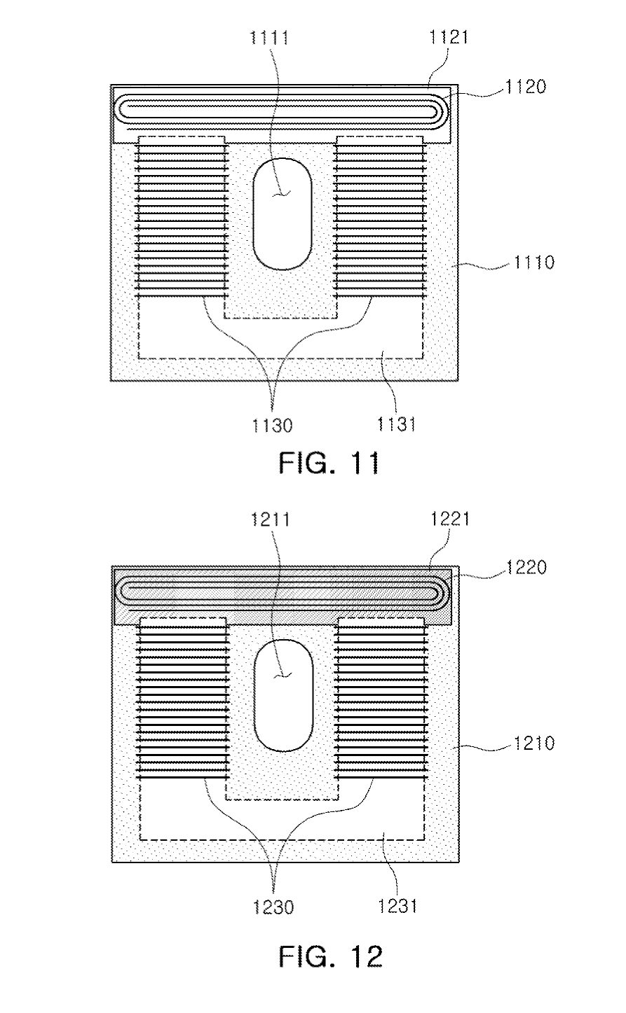

Referring to an example illustrated in FIG. 11, a coil module includes a substrate 1110 including a through-hole 1111, and a first coil 1120 and second coils 1130 formed around the through-hole 1111.

The substrate 1110 includes a first magnetic body 1121 and a second magnetic body 1131 inside or outside of the substrate 810. The first magnetic body 1121 and the second magnetic body 1131 are formed on the same layer of the substrate 1110.

The first coil 1120 is a spiral coil wound on one surface of the first magnetic body 1121 in an upper portion of the substrate 1110, that is, a portion of the substrate 1110 above the through-hole 1111.

The second coils 1130 are two solenoid coils 1130 wound around the second magnetic body 1131 on the left and right sides of the through-hole 1111.

The second magnetic body 1131 is formed as one magnetic body, and a first solenoid coil 1130 and a second solenoid coil 1130 are wound on different portions of the second magnetic body 1131.

In the example illustrated in FIG. 11, the second magnetic body 1131 has a shape of a ‘U’ having two legs, the first solenoid coil 1130 is wound on a first leg of the second magnetic body 1131, and the second solenoid coil 1130 is wound on a second leg of the second magnetic body 1131.

Referring to an example illustrated in FIG. 12, a coil module includes a substrate 1210 including a through-hole 1211, and a first coil 1220 and second coils 1230 formed around the through-hole 1211.

The substrate 1210 includes a first magnetic body 1221 and a second magnetic body 1231 inside or outside of the substrate 1210. The first magnetic body 1221 and the second magnetic body 1231 are formed in or on different layers. In one example, the first magnetic body 1221 is formed on an upper surface of the substrate 1210, and the second magnetic body 1231 is formed inside the substrate 1210.

The first coil 1220 is a spiral coil wound on one surface of the first magnetic body 1221 in an upper portion of the substrate 1210, that is, a portion of the substrate 1210 above the through-hole 1211.

The second coils 1230 are two solenoid coils 1230 wound around the second magnetic body 1231 on the left and right sides of the through-hole 1211.

The second magnetic body 1231 is formed one magnetic body, and a first solenoid coil 1230 and a second solenoid coil 1230 are wound on different portions of the second magnetic body 1231.

In the example illustrated in FIG. 12, the second magnetic body 1231 has a shape of a ‘U’ having two legs, the first solenoid coil 1230 is wound on a first leg of the second magnetic body 1231, and the second solenoid coil 1230 is wound on a second leg of the second magnetic body 1231.

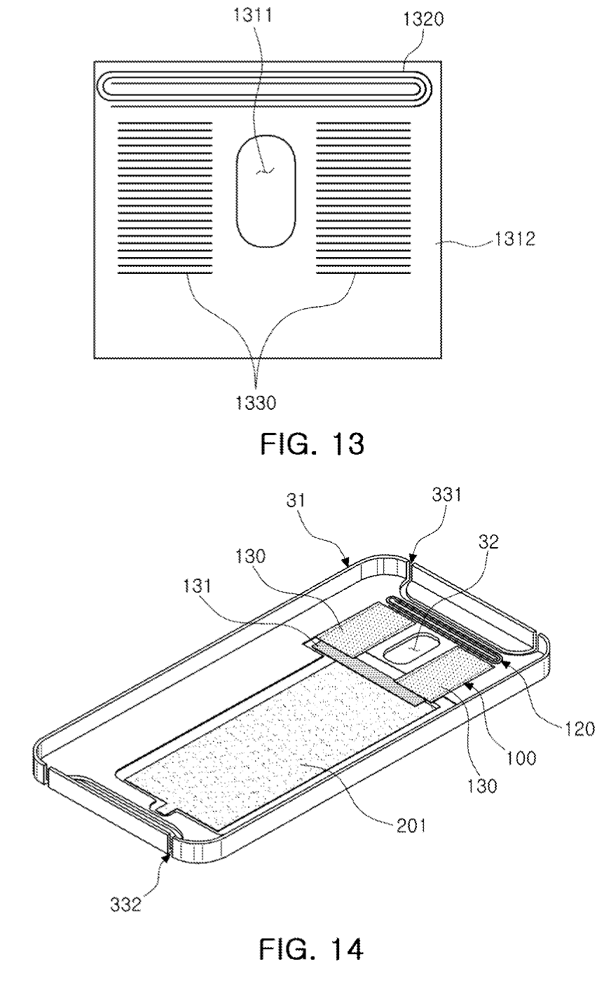

Referring to an example illustrated in FIG. 13, a coil module includes a magnetic substrate 1310 including a through-hole 1311, and a first coil 1320 and second coils 1330 formed around the through-hole 1311.

The magnetic substrate 1310 is formed of a magnetic material.

The first coil 1320 is formed in a spiral form above the through-hole 1311.

The second coils 1330 are formed on the left and right sides of the through-hole 1311. That is, the second coils 1330 are solenoid coils 1330 formed by forming patterns on opposite surfaces of the magnetic substrate 1310, for example, an upper surface and a lower surface of the magnetic substrate 1310, and electrically connecting both ends of the patterns on the opposite surfaces of the magnetic substrate 1310 to each other through vias formed in the magnetic substrate 1310 similarly to the example illustrated in FIGS. 3, 4A, and 4B to form the solenoid coils 1330 so that the solenoid coils are wound around the magnetic substrate 1310.

Although not illustrated in FIG. 13, a slit may be formed in the magnetic substrate 1310 illustrated in FIG. 13 to enable a magnetic field formed by the first coil 1320 or the second coils 1330 to flow through the slit. Such a slit may be implemented in various forms.

As described above, the coil module may be modified in various ways with respect to the first coil and the second coil. All of the examples of the coil module described above with respect to FIGS. 3 through 13 have a common characteristic in that at least a portion of the first coil is formed above the through-hole, and the at least one second coil is formed on either one or both of the left and right sides of the through-hole. This enables a magnetic coupling force between the coil module and a reader, such as the magnetic card reader 10 in FIG. 1 and the NFC card reader 11 in FIG. 2, to be higher at a position of the coil module within the mobile terminal.

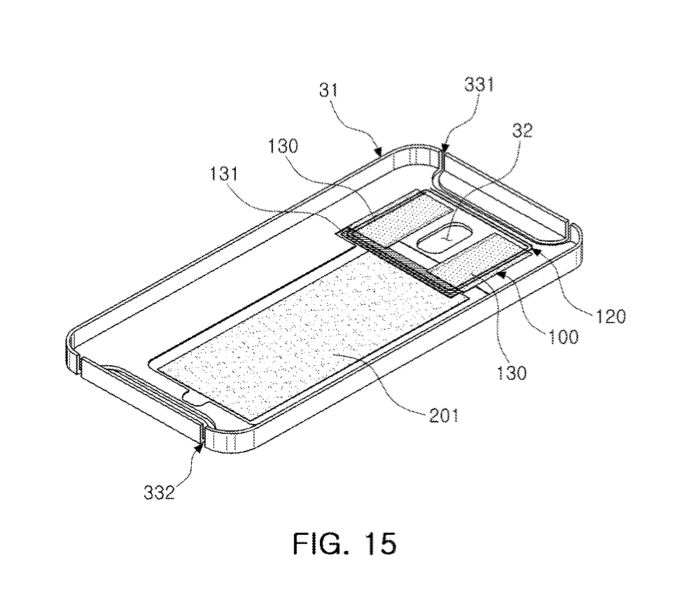

Hereinafter, a coil module applied to the mobile terminal will be described in more detail with reference to FIGS. 14 and 15.

FIGS. 14 and 15 are views illustrating examples of a case of a mobile terminal and a coil module applied thereto.

Referring to an example illustrated in FIGS. 14 and 15, the mobile terminal includes a metal case 31 and a coil module 100.

The metal case 31 is formed of a metal and includes a camera hole 32. In addition, the metal case 31 includes a first slit 331 adjacent to the camera hole 32 and formed in an upper portion of the metal case 31, and a second slit 332 formed in a lower portion of the metal case 31.

A statement that the first slit 331 is ‘adjacent’ to the camera hole 32 includes a case in which the first slit 331 and the camera hole 32 are in contact with each other, and a case in which the first slit 331 is slightly spaced apart from the camera hole 32, but is near the camera hole 32. That is, a statement that the first slit 331 is ‘adjacent’ to the camera hole 32 includes a case in which the first slit 331 is not connected to the camera hole 32 but is near the camera hole 32 as in the examples illustrated in FIGS. 14 and 15, and a case in which the first slit 331 is connected to the camera hole 32, unlike in the examples illustrated in FIGS. 14 and 15. When the first slit 331 is near the camera hole 32, the first slit 331 may still be considered to be ‘adjacent’ to the camera hole 32 even if one or more elements are disposed between the first slit 331 and the camera hole 32, like the spiral coil 120 in the examples illustrated in FIGS. 14 and 15.

In the examples illustrated in FIGS. 14 and 15, the first slit 331 and the second slit 332 are formed in a shape of a ‘U’, but this is merely illustrative. Therefore, the form, structure, and shape of the first slit 331 and the second slit 332 may be modified in various ways.

The coil module 100 includes the substrate in which the through-hole is formed, the spiral coil 120 formed on the substrate, at least a portion of the spiral coil 120 being formed on a portion of the substrate above the through-hole, and at least one solenoid coil 130 formed on either one or both of the left side and the right side of the through-hole.

Examples of the coil module 100 are described above with reference to FIGS. 3 through 13.

The coil module 100 is formed around the camera hole 32. That is, the coil module 100 includes the through-hole, and the through-hole of the coil module 100 is aligned with the camera hole 32 of the metal case 31.

Therefore, an upper portion of the coil module 100 is adjacent to the first slit 331, enabling a portion of the magnetic field formed by the coil module 100 to pass through the first slit 331 and form a magnetic field outside the metal case 31.

Since a lower portion of the coil module 100 is positioned inside the metal case 31, the mobile terminal further includes a separate magnetic plate 201. One end of the magnetic plate 201 is adjacent to the coil module 100. A statement that one end of the magnetic plate 201 is ‘adjacent’ to the coil module 100 includes a case in which at least portions of the magnetic plate 201 and the coil module 100 overlap each other, a case in which ends of the magnetic plate 201 and the coil module 100 are in contact with each other, and a case in which the magnetic plate 201 is slightly spaced apart from the coil module 100.

The magnetic plate 201 forms a magnetic path to concentrate the magnetic field formed by the coil module 100. Thus, the magnetic plate 201 affects the shape and strength of the magnetic field formed by the coil module 100.

One end of the magnetic plate 201 is disposed to adjacent to the lower portion of the coil module 100, and the other end of the magnetic plate 201 is disposed adjacent to the second slit 332.

Accordingly, a portion of the magnetic field formed by the coil module 100 passes through the magnetic path formed by the magnetic plate 201, and then passes through the second slit 332 and forms a magnetic field outside the metal case 31.

In one example, the magnetic plate 201 adjacent to the substrate of the coil module 100 is formed as a component of the coil module 100. Thus, in this example, the coil module 100 includes the magnetic plate 201.

As a result, since the magnetic field formed by the coil module 100 flows through the first slit 331, the magnetic plate 201, and the second slit 332, a uniform magnetic field is formed outside the mobile terminal. In addition, since the metal case 31 includes the camera hole 32, the magnetic field formed by the coil module 100 also flows through the camera hole 32 to form the uniform magnetic field outside the mobile terminal.

The substrate of the coil module 100 includes a magnetic layer 131, and one end of the magnetic plate 201 is adjacent to the magnetic layer 131 to enable the magnetic field formed by the coil module 100 to easily flow along the magnetic plate 201.

In one example, the magnetic plate 201 is formed on one surface of a battery (not shown) provided in the mobile terminal. For example, the magnetic plate 201 may be a magnetic sheet attached to one surface of the battery.

The examples of the coil module described above may be included in an electronic device such as a mobile terminal to support short-range communication and magnetic secure transmission.

The examples of coil module described above enable a plurality of coils for different communication schemes to be disposed on one substrate.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil module comprising:
a substrate comprising a magnetic body and a through-hole;
a first coil comprising a spiral pattern formed on one surface of the substrate; and
a second coil comprising at least one solenoid pattern formed around the magnetic body,
wherein the first coil and the second coil are formed around the through-hole.

2. The coil module of claim 1, wherein the spiral pattern is formed around a first axis perpendicular to a surface of the substrate, and
the solenoid pattern is formed around a second axis parallel to the surface of the substrate.

3. The coil module of claim 1, wherein the first coil is formed on an upper portion of the substrate above the through-hole, and
the second coil is formed on a portion of the substrate on either one or both of a left side and a right side of the through-hole.

4. The coil module of claim 3, wherein the substrate is a multilayer substrate formed by stacking a plurality layers, and comprises a first magnetic body disposed in or on any one layer among the plurality of layers, and a second magnetic body disposed in or on a same layer among the plurality of layers as the first magnetic body,
the first magnetic body is formed in a region of the substrate opposing the first coil, and
the second coil is wound around the second magnetic body.

5. The coil module of claim 3, wherein the substrate is a multilayer substrate formed by stacking a plurality layers, and comprises a first magnetic body disposed in or on a first layer among the plurality of layers, and a second magnetic body disposed in or on a second layer among the plurality of layers different from the first layer,
the first magnetic body is formed in a region of the substrate opposing the first coil, and
the second coil is wound around the second magnetic body.

6. The coil module of claim 1, wherein the first coil is formed along an outer portion of the substrate, the outer portion comprising an upper portion of the substrate above the through-hole, and
the second coil is formed in a portion of the substrate on either one or both a left side and a right side of the through-hole.

7. The coil module of claim 1, wherein the at least one solenoid pattern comprises:
a first solenoid pattern formed on a portion of the substrate on a left side of the through-hole; and
a second solenoid pattern formed on a portion of the substrate on a right side of the through-hole.

8. The coil module of claim 7, wherein the first solenoid pattern and the second solenoid pattern are wound on different portions of the magnetic body.

9. The coil module of claim 8, wherein the magnetic body has a shape of a U having a first leg and a second leg,
the first solenoid pattern is wound on the first leg of the magnetic body, and
the second solenoid pattern is wound on the second leg of the magnetic body.

10. The coil module of claim 7, wherein a number of windings of the first solenoid pattern is different from a number of windings of the second solenoid pattern.

11. The coil module of claim 1, wherein the at least one solenoid pattern is one solenoid pattern formed on a portion of the substrate on either a left side or a right side of the through-hole.

12. The coil module of claim 1, wherein the at least one solenoid pattern comprises:
a plurality of first patterns formed on the one surface of the substrate;
a plurality of second patterns formed on another surface of the substrate; and
a plurality of vias penetrating through the substrate and electrically connecting both ends of the plurality of first patterns to both ends of the plurality of second patterns to form the at least one solenoid pattern around the magnetic body.

13. The coil module of claim 1, wherein the substrate is a magnetic substrate formed of a magnetic material and constituting the magnetic body,
the spiral pattern is formed on one surface of the magnetic substrate, and
the at least one solenoid pattern comprises:
a plurality of first patterns formed on the one surface of the magnetic substrate;
a plurality of second patterns formed on another surface of the magnetic substrate; and
a plurality of vias penetrating through the magnetic substrate and electrically connecting both ends of the plurality of first patterns to both ends of the plurality of second patterns to form the at least one solenoid pattern around the magnetic body.

14. The coil module of claim 1, further comprising a magnetic plate adjacent to the substrate and forming a magnetic path configured to concentrate a magnetic field formed by the coil module.

15. A mobile terminal comprising:
a metal case formed of a metal and comprising a camera hole; and
a coil module comprising:
a substrate comprising a through-hole;
a spiral coil formed on the substrate, at least a portion of the spiral coil being formed on a portion of the substrate above the through-hole; and
at least one solenoid coil formed on a portion of the substrate on either one or both of a left side and a right side of the through-hole,
wherein the coil module is disposed in or on the metal case so that the through-hole is aligned with the camera hole.

16. The mobile terminal of claim 15, wherein the camera hole is formed in an upper portion of the metal case,
the metal case further comprises:
a first slit formed in the upper portion of the metal case adjacent to the camera hole; and
a second slit formed in a lower portion of the metal case, and
the mobile terminal further comprises a magnetic plate disposed in or on the metal case and having one end adjacent to the coil module and another end adjacent to the second slit.

17. A coil module comprising:
a substrate comprising a magnetic body and a through-hole;
a spiral coil formed on the substrate so that at least a portion of the spiral coil is formed in a first region of the substrate between the through-hole and a first edge of the substrate; and
a solenoid coil formed around the magnetic body and formed in a second region of the substrate between the through-hole and a second edge of the substrate oriented in a different direction than the first edge of the substrate.

18. The coil module of claim 17, wherein the spiral coil is formed along a portion of the substrate adjoining an entire perimeter of the substrate comprising the first edge of the substrate and the second edge of the substrate so that the through-hole and the solenoid coil are disposed within the spiral coil.

19. The coil module of claim 17, wherein an entirety of the spiral coil is formed in the first region of the substrate, and
the substrate further comprises another magnetic body disposed in the first region of substrate and opposing the spiral coil.

20. The coil module of claim 17, wherein the magnetic body is disposed inside the substrate, and
the solenoid coil comprises:
a plurality of first vias penetrating through the substrate on one side of the magnetic body;
a plurality of second vias penetrating through the substrate on an opposite side of the magnetic body;
a plurality of first patterns formed on a first surface of the substrate, each of the first patterns connecting a different one of the first vias to a different one of the second vias; and
a plurality of second patterns formed on a second surface of the substrate, each of the second patterns connecting a different one of the first vias to a different one of the second vias.
